(19) United States
(12) Patent Application Publication
(10) Pub. No.: US 2026/0261300 A1
(43) Pub. Date: Sep. 3, 2026

(54) SUBCHANNEL BONDING AND SPLITTING

(71) Applicant: CesiumAstro, Inc., Austin, TX (US)

(72) Inventors: James Wesley McCoy, Liberty Hill, TX (US); Thomas Magesacher, Austin, TX (US)

(21) Appl. No.: 19/553,628

(22) Filed: Mar. 2, 2026

Related U.S. Application Data
(60) Provisional application No. 63/765,684, filed on Mar. 2, 2025.

(51) Int. Cl. H04B 7/06

(52) U.S. Cl. CPC H04B 7/0617

(57) ABSTRACT

The present disclosure provides for the use of a front-end circuit coupled to an antenna, a beamforming network configured to communicate one or more beams to other circuitry, and a signal processing circuit coupled between the front-end circuit and the beamforming network. The processing circuit may include a receive path, a transmit path, and alignment circuitry coupled to the front-end circuit to selectively align signal components to a raster. The receive path may fractionally interpolate a signal from the alignment circuitry to determine one or more sub-bands from each of multiple subchannels within the signal and to fractionally decimate and bond the sub-bands to reconstruct and provide the subchannels to the beamforming network. The transmit path may fractionally interpolate subchannels from the beamforming network to determine one or more sub-bands from each subchannel and to combine, bond, and fractionally decimate the sub-bands to reconstruct and provide the subchannels to the alignment circuitry for transmission.

### CROSS-REFERENCE TO RELATED APPLICATIONS

This application claims the benefit of U.S. Provisional Application No. 63/765,684, filed on Mar. 2, 2025, which is hereby incorporated by reference in its entirety.

### TECHNICAL FIELD

The present disclosure is generally related to reception and transmission of radio frequency signals, such as satellite signals, and in at least one embodiment to systems and methods of subchannel bonding and splitting in reception and transmission of satellite signals.

### BACKGROUND

Modern satellite and radio-frequency communication systems increasingly rely on digital signal processing techniques to handle signals composed of multiple subchannels having different bandwidths, center frequencies, and beam assignments. Conventional systems commonly use fixed-grid channelizers, such as FFT-based filter banks or fractional resamplers, to separate, translate, and recombine subchannels within a wideband signal. While these approaches can be effective, they often impose rigid constraints on subchannel placement and bandwidth, or require computationally expensive operations such as high-order fractional resampling and continuous frequency shifting. As system demands grow to support dynamic beamforming, variable bandwidth allocation, and flexible routing of signals, these conventional solutions may suffer from increased processing complexity, reduced efficiency, and limited scalability, particularly when subchannels do not naturally align to a predefined frequency raster.

### BRIEF DESCRIPTION OF THE DRAWINGS

Various embodiments in accordance with the present disclosure will be described with reference to the drawings, in which:

FIG. 1A depicts a block diagram of a system including multiple antennas and a beamformer, and configured to send and receive signals that include multiple channels, according to example embodiments;

FIG. 1B depicts a block diagram of a system including one antenna and no beamformer, and configured to send and receive signals that include multiple channels, according to example embodiments;

FIG. 2 depicts a diagram of a process of subchannel bonding in a digital downconverter for a received signal, according to example embodiments;

FIG. 3 depicts a block diagram of a portion of a receive path configured to provide subchannel bonding in the digital downconverter, according to example embodiments;

FIG. 4 depicts a diagram of a process of subchannel splitting in a digital upconverter for a signal to be transmitted, according to example embodiments;

FIG. 5 depicts a block diagram of a portion of a transmit path configured to provide subchannel splitting in the digital upconverter, according to example embodiments;

FIG. 6 depicts a diagram of a process of subchannel alignment through resampling or clock-rate adjustment and digital frequency shift or local oscillator shift, according to example embodiments;

FIG. 7 depicts a diagram of a process of encapsulation through oversampling in the frequency domain and alignment at baseband through one or more of digital frequency shift or rate change, according to example embodiments;

FIG. 8 depicts a diagram of a process of aligning subchannels to raster intervals in the digital upconverter, according to example embodiments;

FIG. 9 depicts a flow diagram of a method of subchannel bonding in a digital downconverter for a received signal, according to example embodiments; and

FIG. 10 depicts a flow diagram of a method of subchannel splitting in a digital upconverter for a signal to be transmitted, according to example embodiments;

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The present disclosure provides for flexibly splitting and bonding subchannels using fractional polyphase filter banks integrated within digital downconverter and digital upconverter architectures. In a receive path, an incoming signal is slightly oversampled using a fractionally interpolating polyphase analysis bank to form uniform-bandwidth sub-bands, which are then selectively bonded and decimated using polyphase synthesis banks to reconstruct desired subchannels for beamforming. In a transmit path, subchannels are split into sub-bands, combined across beams as needed, and bonded to form a composite outgoing waveform. Alignment circuitry supports either raster realignment through resampling and frequency shifting or encapsulation of spectral components within an existing raster using FFT oversampling and baseband processing. By enabling near-perfect reconstruction with reduced reliance on high-cost fractional resamplers, the disclosed techniques improve flexibility, computational efficiency, and scalability relative to conventional fixed-grid channelization approaches.

Embodiments are described below that, in a receive path, can utilize a polyphase analysis bank to slightly oversample a received signal into distinct component sub-bands of the same bandwidth from each of the multiple subchannels and that utilize a decimating polyphase synthesis bank to bond the component sub-bands to re-form proper subchannels, which may be passed to the beamformer. In some embodiments, an oversampling and bonding processes may be performed within a digital downconverter operation. In a transmit path, the systems and methods may utilize a slightly interpolating polyphase analysis bank to split subchannels from the beamformer into uniform sub-band components and a polyphase synthesis bank to slightly decimate, bond, and combine the sub-band components to form a composite waveform, which may be routed to the antenna. In some embodiments, the splitting and aggregating operations may be performed within a digital upconverter operation.

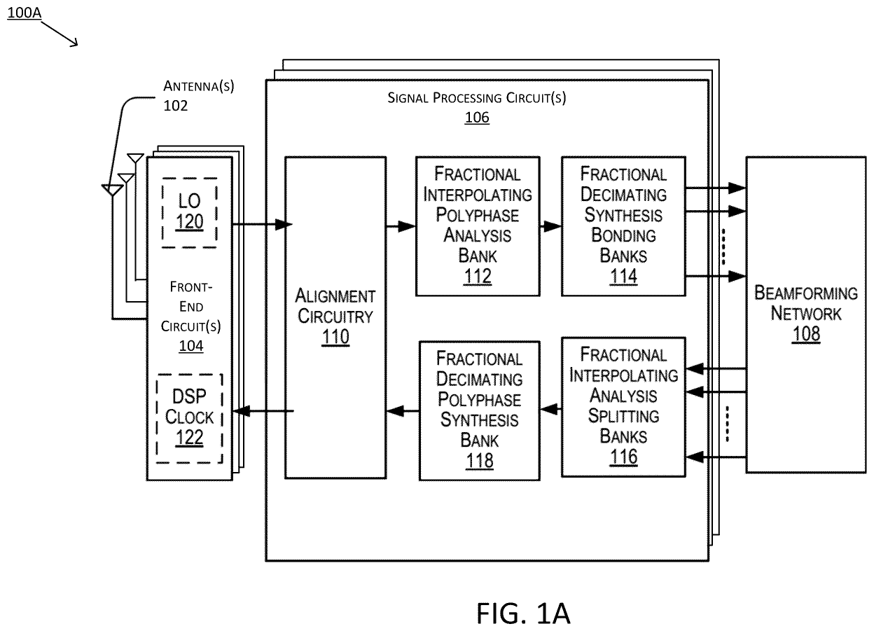

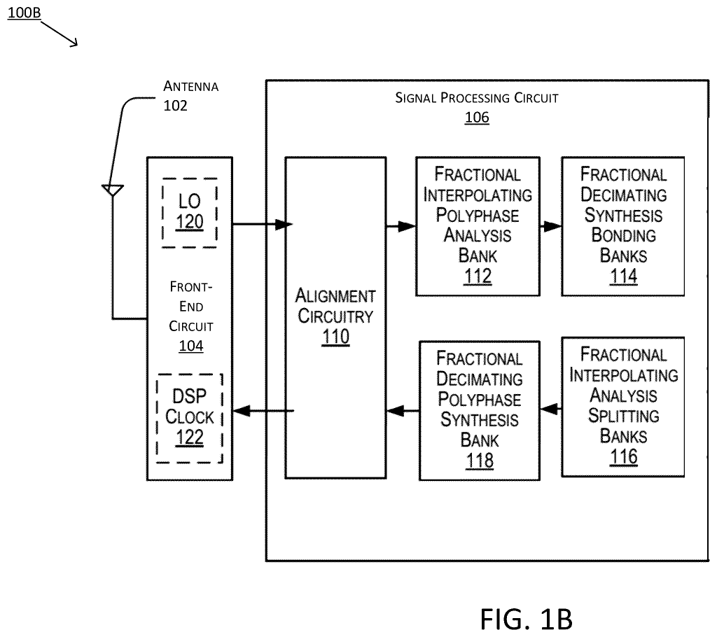

FIG. 1A depicts a block diagram of a system 100A configured to send and receive signals that include multiple channels, in accordance with certain embodiments of the present disclosure. The system 100A may include one or more antenna(s) 102 configured to receive radio frequency signals from a signal source, such as a mobile station, a satellite, a ground station, another source, or any combination thereof. The system 100A may include one or more analog front-end circuits 104, which may be coupled to the one or more antenna(s) 102 and which may be configured to amplify, level shift, or otherwise adjust received signals from the one or more antenna(s) 102 or to drive signals for transmission via the antenna(s) 102. In some embodiments, the one or more front-end circuits 104 may include a local oscillator (LO) 120, a digital signal processing (DSP) clock 122, or both.

The system 100A may include signal processing circuit(s) 106 that are coupled between the one or more front-end circuits 104 and a beamforming network 108. The signal processing circuit(s) 106 may be configured to process received signals to extract the subchannel data and to align the subchannel data to selected timing signals for transmission or for further processing.

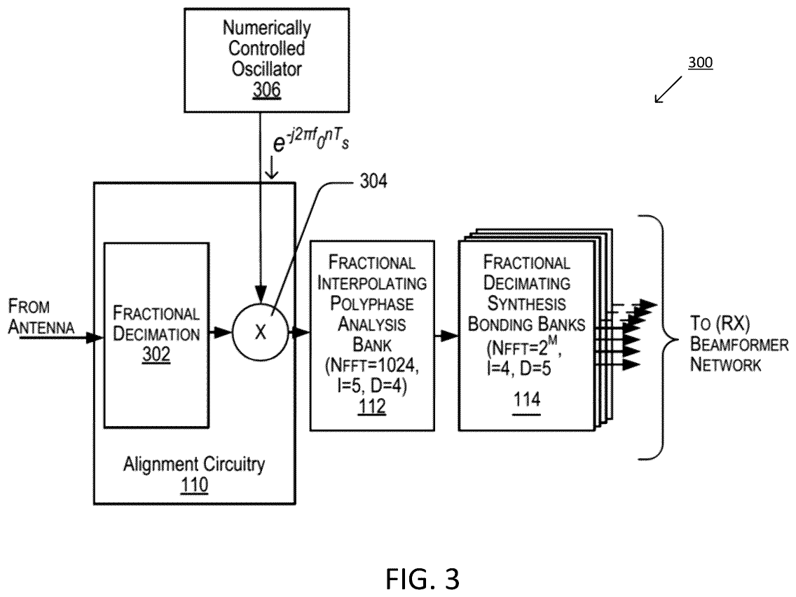

The signal processing circuit(s) 106 may include alignment circuitry 110, which may be configured to provide fractional decimation and phase-shift operations in the receive path and to provide fractional interpolation and phase-shift operations in the transmit path. In an example, using a digital signal processor (DSP) clock 122 and a local oscillator (LO) 120 (or a numerically controlled oscillator (NCO) 306 in FIG. 3), the incoming/outgoing signal may be mapped to a selected raster. In some embodiments, the subchannels of the incoming/outgoing signals can be aligned to the selected raster by adjusting the sample rate, adjusting the LO 120, and adjusting spectral components of the signal. In an example, by adjusting the DSP clock 122, the sample rate and hence the raster is adjusted. The frequency separation on the raster may be determined by the length of the Fast Fourier Transform (FFT) and the sample rate may be determined according to the following equation:

$${f}_{Δ} = \frac{{f}_{s}}{{N}_{f f t}} \qquad ( 1 )$$

where f_{Δ} represents the frequency adjustment, fₛ represents the sample frequency, and N_{fft} represents the length of the FFT. In some embodiments, the raster offset may be adjusted by the LO 120.

The alignment circuitry 110 may be configured to align to a raster by resampling and shifting the spectral components of the signal. The alignment circuitry 110 may use fractional decimation to create the selected grid spacing and a frequency shift can align the grid. A fractional re-sampler may cost up to 32×2 real multiply operations per sample and a frequency shift may cost an additional complex multiply operation, which may be very expensive computationally.

In other embodiments, the alignment circuitry 110 may be configured to encapsulate the received signal in the framework of an existing raster grid, which is not aligned to the signal raster. The encapsulated signal may be processed without the added multiply operations performed by the re-sampler in the example described above. Increasing the resolution of an FFT may cost one-half of a complex multiply operation per sample, which is computationally cheap when compared to a fractional re-sampler. In some embodiments, a baseband signal can be resampled with even a difficult rate change. A deterministic frequency shift may be applied in the baseband processing, shifting the burden of the raster alignment to baseband processing.

The signal processing circuit(s) 106 may include one or more fractionally interpolating polyphase analysis banks 112 including an input coupled to an output of the alignment circuitry 110 and including an output. The fractionally interpolating polyphase analysis bank 112 may be configured to slightly oversample components of the incoming signals into distinct sub-bands of the same bandwidth. The fractionally interpolating polyphase analysis bank 112 may oversample the FFT bins to ensure “perfect” reconstruction of the subchannels.

The signal processing circuit(s) 106 may include fractionally decimating synthesis bonding banks 114 including an input coupled to the output of the fractionally interpolating polyphase analysis bank 112 and multiple outputs coupled to the beamforming network 108. The fractionally decimating synthesis bonding banks 114 may be configured to slightly decimate and bond the sub-bands to re-form proper subchannels, which may be passed to the beamforming network where wideband signals may be processed with true time delay and narrowband signals can be processed through digital phase shifters. The fractionally decimating synthesis bonding banks 114 may be configured to reconstruct the “bonded” spectral components in a regenerative system to produce the subchannel outputs. Bent-pipe systems may bypass the reconstruction (bonding) operation and may simply forward the sub-bands. Zero stuffing may be beneficial in the bonding phase where the FFT size is increased and zeros are added to ends of the FFT bins.

In a transmit mode, subchannels may be passed to the signal processing circuit(s) 106 from the beamforming network 108, where wideband signals were processed with true time delay and narrowband signals were processed with digital phase shifters. The signal processing circuit(s) 106 may include one or more fractionally interpolating analysis splitting banks 116 including a plurality of inputs coupled to the beamforming network 108 and including an output. In the transmit path, the fractionally interpolating analysis splitting banks 116 may be configured to receive the subchannels from the beamforming network and to split the subchannels into uniform bandwidth pieces (sub-band components).

The signal processing circuit(s) 106 may include a fractionally decimating polyphase synthesis bank 118 including an input coupled to the output of the fractionally interpolating analysis splitting banks 116 to receive the uniform bandwidth pieces and including an output coupled to the alignment circuitry 110. The fractionally decimating polyphase synthesis bank 118 may be configured to slightly decimate the sub-band components and to bond and combine the slightly decimated sub-band components to form a composite waveform. The fractionally decimating polyphase synthesis bank 118 may be configured to recombine the sub-bands to ensure “perfect” reconstruction of the subchannels.

In the transmit channel, the alignment circuitry 110 may be configured to resample and shift the spectrum of the reconstructed subchannels to realign the subchannels to the raster or optionally to encapsulate the spectral components of the outgoing signal. The resulting reconstructed waveform signal may be passed to the one or more analog front-end circuits 104 for transmission via the one or more antenna(s) 102.

It should be appreciated that the signal processing circuit(s) 106 may perform channelizer operations (which is typically a DSP function) that serve to spectrally encapsulate and route beams at a satellite payload. Ideally, the signal processing circuit(s) 106 can receive signals from a set of directions with variable bandwidths and re-route them back out again on different beams with few restrictions on the routing. The processing may be regenerative or bent pipe.

In the illustrated example, the signal processing circuit(s) 106 may use a cascaded polyphase architecture, which may represent the best techniques under constraints of complexity and simplicity. The cascaded polyphase architecture can efficiently encapsulate and reroute signals based on a fractional re-sampler with a mixer provided by the alignment circuitry 110. The purpose of the alignment circuitry 110 is to shift and resample the signal in the frequency domain. The fractional re-sampler may not be implemented in the frequency domain, which may introduce a marginal complexity penalty if the filters are extremely efficient. The channelizer in isolation may include a Fast Fourier Transform (FFT) block, an Inverse FFT (IFFT) block, and a switch coupled between the FFT block and the IFFT block.

The first step in a polyphase channelizer is the digital downconverter (DDC). The signal processing circuit(s) 106 may use or provide a fractional resampling DDC. The equations for the fractional DDC are given below. The complex exponential term eventually becomes an FFT operation, which ultimately serves as a bank of mixers. The fractional resampling begins according to the following equation:

$${X}_{k} ( m ) = {\sum }_{n = - ∞}^{∞} x ( n ) {e}^{\frac{- j 2 π k n}{M}} h ( m M D - n l ) \qquad ( 2 )$$

where the decimation factor is MD and the interpolation factor is I. In this instance, the ratio of I/D may be restricted to be less than unity and more than ½. In the case where we need to decimate beyond ½, the size of the FFT may be increased by a factor of 2. The signal processing circuit(s) 106 may support a variable sized FFT as well as a handful of fractional resampling ratios. A commutation function may be implemented as follows.

$$n = r + s M . \qquad ( 3 )$$

By substituting equation 3 into equation 2, the following equation is produced:

$${X}_{k} ( m ) = {\sum }_{s = - ∞}^{∞} {\sum }_{r = 0}^{M - 1} x ( r + s M ) {e}^{\frac{- j 2 π k ( r + s M )}{M}} h ( m M D - rI - sMI ) \qquad ( 4 )$$

By switching the order of summation, simplifying the exponential, and re-expressing x, the equation can be rewritten as:

$${X}_{k} ( m ) = {\sum }_{r = 0}^{M - 1} {e}^{\frac{- j 2 π k r}{M}} {\sum }_{s = - ∞}^{∞} {x}_{r} ( s ) h ( m M D - rI - sMI ) \qquad ( 5 )$$

where xᵣ(s) is the s^{th} sample on the r^{th} leg of the commutator output.

Continuing with the algebraic manipulations, equation 5 may be adjusted to provide a polyphase implementation as follows:

$$mMD - rI = MI ⌊ \frac{mMD - rI}{MI} ⌋ + ( mMD - rI ) mod ( MI ) . \qquad ( 6 )$$

Equation 6 may be rearranged as follows:

$${X}_{k} ( m ) = {{\sum }_{r = 0}}^{M - 1} {e}^{\frac{- j 2 π kr}{M}} {{\sum }_{s = - ∞}}^{∞} {x}_{r} ( s ) h ( MI ( ⌊ \frac{mMD - rI}{MI} ⌋ - s ) + ( mMD - rI ) mod ( MI ) ) \qquad ( 7 )$$

A streaming implementation of a fractional polyphase analysis (filter) bank may be produced by defining the following ratio:

$$\tilde{s} = ⌊ \frac{mMD - rI}{MI} ⌋ - s , \qquad ( 8 )$$

The ratio may be substituted into equation 7 as follows:

$${X}_{k} ( m ) = {\sum }_{r = 0}^{M - 1} {e}^{\frac{- j 2 π kr}{M}} {\sum }_{s = 0}^{{N}_{\frac{taps}{phase}} - 1} {x}_{r} ( ⌊ \frac{mMD - rI}{MI} ⌋ - s ) h ( MIs + ( mMD - rI ) mod ( MI ) ) \qquad ( 9 )$$

where the ratio

$$\vert \frac{mMD - rI}{MI} \vert$$

determines the head pointer to the location of the xᵣ values used for the filtering function and a trailing portion of Equation 9 ((mMD−rI)mod(MI)) determines the phase of the MI-phase polyphase filter. The limits on the inner summation can be scoped to the number of taps per phase of the MI-phase polyphase filter.

In the digital upconverter process, it is possible to derive a fractionally resampled polyphase synthesis bank. The initial equation is as follows:

$$x ( n ) = {\sum }_{k = 0}^{M - 1} {e}^{\frac{j 2 π nk}{M}} {\sum }_{m = - ∞}^{∞} {X}_{k} ( m ) h ( nD - mMI ) \qquad ( 10 )$$

As in the DDC, the commutator is defined as follows:

$$n = r + sM . \qquad ( 11 )$$

Substituting the commutator into equation 10 results in the following equation:

$$x ( n ) = {\sum }_{k = 0}^{M - 1} {e}^{\frac{j 2 π ( r + sM ) k}{M}} {\sum }_{m = - ∞}^{∞} {X}_{k} ( m ) h ( ( r + sM ) D - mMI ) \qquad ( 12 )$$

Switching the order of summation produces the following equation:

$$x ( n ) = {\sum }_{m = - ∞}^{∞} h ( ( r + sM ) D - mMI ) {\sum }_{k = 0}^{M - 1} {X}_{k} ( m ) {e}^{\frac{j 2 π rk}{M}} \qquad ( 13 )$$

Simplifying equation 13 over a range of beams produces the following equations:

$${x}_{r} ( m ) = {\sum }_{k = 0}^{M - 1} {X}_{k} ( m ) {e}^{\frac{j 2 π rk}{M}} \qquad ( 14 )$$

$$x ( n ) = {\sum }_{m = - ∞}^{∞} h ( ( r + sM ) D - mMI ) {x}_{r} ( m ) \qquad ( 15 )$$

Similarly, to produce a polyphase filter, the equation is set as follows:

$$( r + sM ) D - nMI = MI ( ⌊ \frac{( r + sM ) D}{MI} ⌋ - m ) + ( r + sM ) D mod MI \qquad ( 16 )$$

$$and$$

$$\tilde{m} = ⌊ \frac{( r + sM ) D}{MI} ⌋ - m . \qquad ( 17 )$$

Substituting into equation 15, the resulting equation appears below:

$$x ( n ) = {\sum }_{m = 0}^{{N}_{\frac{taps}{phase}} - 1} h ( MIm + nD mod MI ) {x}_{r} ( ⌊ \frac{nD}{MI} ⌋ - m ) \qquad ( 18 )$$

where nD mod MI represents the phase of the polyphase filter and

$$\vert \frac{nD}{MI} \vert$$

represents the data pointer in a streaming implementation,

$$r = n mod M \qquad ( 19 )$$

In the context of bonding sub-bands or subcarriers, the signal processing circuit(s) 106 may implement a “perfect reconstruction” filter bank, which may subdivide a spectrum into many pieces defined by a large FFT. Then, adjacent pieces of the spectrum can be “bonded” to form larger pieces of spectrum that can carry one or more signals to be jointly beamformed. The cornerstone of this technique is the perfect reconstruction filter bank.

The perfect reconstruction filter bank may rely upon Nyquist filters to shape the incoming signals. The reconstruction may oversample the composite input waveform by approximately twenty-five percent (25%) through a polyphase analysis bank. The FFT in the analysis bank may be overclocked by this amount. This leaves room for the tails of the signal in the frequency domain to not alias (I>D). In this case, a Nyquist filter may be used to ensure that the baseband waveforms can be precisely reconstructed. After oversampling the signal, the sub-band components of the signal may be grouped such that each group encapsulates one subchannel. The encapsulated groups may then be separately processed with a decimating (D>I) polyphase synthesis bank of eighty percent (80%) bandwidth, with FFT preferably of length 2^{N} so that it may be efficiently implemented. Zero-padding is available for the synthesis banks, if necessary, by adding zeros to the ends of the FFT bins. The synthesis bank prototype filter need not be a Nyquist filter. In some embodiments, the filter may be configured to have a flat spectral response over 80% of the band.

In some example embodiments, the system 100A may include multiple antennas 102, multiple front-end circuits 104, and multiple signal processing circuits 106. In example embodiments, the plurality of antennas 102 may be configured to receive radio frequency signals from one or more external sources, such as satellites, ground stations, or user terminals, and may also transmit radio frequency signals toward such sources. Each antenna 102 may be coupled to a corresponding front-end circuit 104, and each front-end circuit 104 may be coupled to a corresponding signal processing circuit 106. In example embodiments, the system 100A may be configured such that there is one front-end circuit 104 and one signal processing circuit 106 associated with each antenna 102, although other example embodiments may use different mappings or groupings of antennas, front-end circuits, and signal processing circuits.

In example embodiments, each front-end circuit 104 may condition signals received by a corresponding antenna 102 prior to digital processing. The front-end circuit 104 may include, as a nonlimiting example, a local oscillator 120 configured to support frequency translation and a digital signal processing clock 122 configured to define a sampling rate for downstream processing. The front-end circuit 104 may amplify, filter, level-shift, or otherwise prepare received signals and may provide the prepared signals to the corresponding signal processing circuit 106. In example embodiments, the plurality of signal processing circuits 106 may operate independently or cooperatively, and each signal processing circuit 106 may include alignment circuitry 110, a fractionally interpolating polyphase analysis bank 112, fractionally decimating synthesis bonding banks 114, fractionally interpolating analysis splitting banks 116, and a fractionally decimating polyphase synthesis bank 118, as illustrated in FIG. 1A.

In example embodiments, the plurality of signal processing circuits 106 may provide processed subchannels to a beamforming network 108, which may combine signals from multiple signal processing circuits 106 to form spatial beams. As a nonlimiting example, in a satellite payload, each antenna 102 may correspond to a feed element, each front-end circuit 104 may downconvert and digitize signals received at the feed element, and each signal processing circuit 106 may perform subchannel alignment, splitting, and bonding for signals associated with that feed element. The beamforming network 108 may then combine signals across multiple signal processing circuits 106 to generate one or more beams for downlink transmission or to separate uplink beams for further processing. In example embodiments, other system configurations may be used, including configurations in which multiple antennas share a front-end circuit 104 or a signal processing circuit 106, or configurations in which a single signal processing circuit 106 services multiple antennas, without departing from the scope of the present disclosure.

FIG. 1B illustrates a system 100B for processing a single-stream signal using subchannel splitting and bonding in example embodiments.

The system 100B may include a single antenna 102 coupled to a single front-end circuit 104, and a single signal processing circuit 106, without a beamforming network. The system 100B may be configured to process a scalar signal rather than multiple spatial beams.

In example embodiments, the front-end circuit 104 may be coupled to the antenna 102 and may be configured to condition a received radio-frequency signal or to drive a signal for transmission. As a nonlimiting example, the front-end circuit 104 may include a local oscillator 120 configured to support frequency translation and a digital signal processing clock 122 configured to define a sampling rate for downstream digital processing.

The signal processing circuit 106 may include alignment circuitry 110, which may be coupled to the front-end circuit 104. The alignment circuitry 110 may be configured to selectively align spectral components of a signal to a selected raster. In example embodiments, the alignment circuitry 110 may align the signal by resampling and frequency shifting spectral components or, alternatively, may encapsulate spectral components of the signal within an existing raster and perform alignment at baseband. Other example embodiments may use different alignment techniques while still operating within the scope of the present disclosure.

In example embodiments, a receive path of the signal processing circuit 106 may include a fractionally interpolating polyphase analysis bank 112 and fractionally decimating synthesis bonding banks 114. The fractionally interpolating polyphase analysis bank 112 may oversample a received signal to determine one or more sub-bands associated with one or more subchannels of the received signal. The fractionally decimating synthesis bonding banks 114 may bond and decimate the one or more sub-bands to reconstruct a single output signal. In example embodiments, the reconstructed signal may be provided to a sink associated with a downstream processing element, storage device, or baseband processor, rather than to a beamforming network.

In example embodiments, a transmit path of the signal processing circuit 106 may include fractionally interpolating analysis splitting banks 116 and a fractionally decimating polyphase synthesis bank 118. The fractionally interpolating analysis splitting banks 116 may receive a single input signal from a source, such as a baseband signal generator or digital modem, and may split the input signal into one or more sub-bands. The fractionally decimating polyphase synthesis bank 118 may combine, bond, and decimate the one or more sub-bands to form an outgoing waveform. The outgoing waveform may be provided to the alignment circuitry 110 and then routed to the front-end circuit 104 for transmission via the antenna 102.

As a nonlimiting example, the system 100B illustrated in FIG. 1B may be used in a point-to-point satellite terminal, a gateway modem, or a single-channel radio-frequency transceiver, in which a single uplink or downlink signal is processed without spatial beamforming. Other example embodiments may use the same architecture in terrestrial wireless systems, test equipment, or software-defined radios, and may include additional components or omit certain components depending on system requirements.

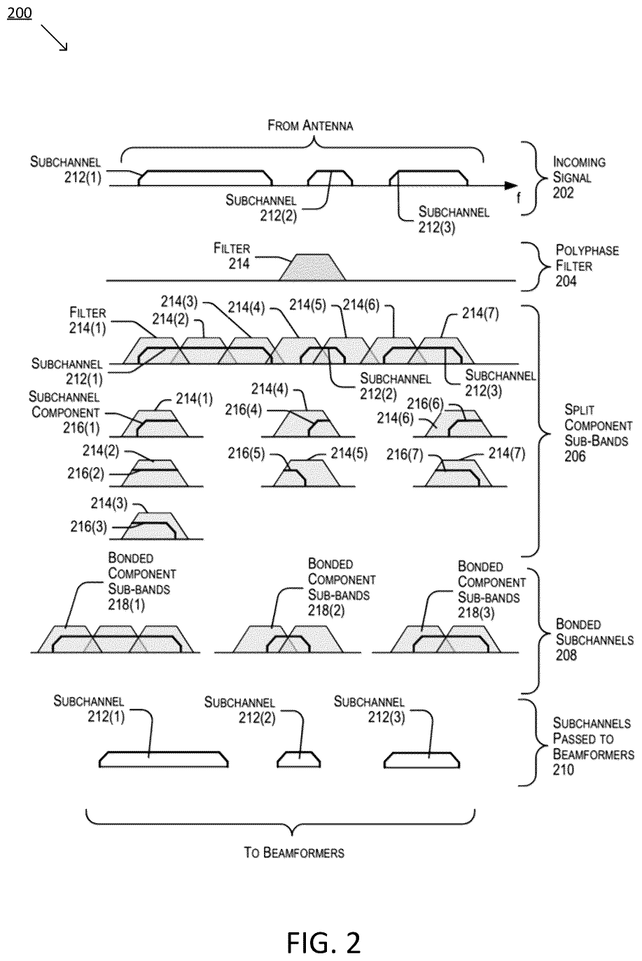

FIG. 2 depicts a diagram of a process 200 of subchannel formation in a digital downconverter according to a desired configuration of beams and bands for a received signal, in accordance with certain embodiments of the present disclosure. In example embodiments, the fractionally decimating synthesis bonding bank 114 may also apply a decimation operation while bonding the sub-band components so that an output sample rate of the reconstructed subchannel matches a rate expected by a beamforming network 108. As a nonlimiting example, in a regenerative satellite receiver, multiple adjacent sub-bands that collectively represent a wideband uplink channel may be assembled and bonded to reconstruct the uplink channel prior to beamforming. The reconstructed subchannels may then be provided to the beamforming network 108 for spatial processing. Other example embodiments may assemble different numbers of sub-bands or may route reconstructed subchannels to different downstream processing elements.

In the process 200, an incoming signal 202 is received from the antenna(s) 102. The incoming signal 202 may be comprised of a plurality of subchannels 212(1), 212(2), and 212(3) which may have different bandwidths and different center frequencies. While three subchannels 212 are shown, it should be understood that the incoming signal at 202 may be comprised of any number of subchannels 212.

The process 200 may utilize a polyphase filter 204 (produced by the fractionally interpolating polyphase analysis bank 112), which may be applied to the incoming signal 202. In some embodiments, the polyphase filter 204 may be implemented as a Nyquist filter. Other filters are also possible.

The process 200 may include forming component sub-bands from the subchannel 212 by oversampling the incoming signal using the polyphase analysis bank 112, at 206. In this example, the filter 214 may be applied to the incoming signal 202 to determine a plurality of sub-bands corresponding to portions of the subchannels 212. For example, filters 214(1), 214(2), and 214(3) may overlap the first subchannel 212(1). Filters 214(4) and 214(5) may overlap the second subchannel 212(2). Filters 214(6) and 214(7) may overlap the third subchannel 212(3).

The filters 214(1), 214(2), and 214(3) may produce distinct subchannel components (sub-bands) 216(1), 216(2), and 216(3). The filters 214(4) and 214(5) may produce distinct subchannel components 216(4) and 216(5). The filters 214(6) and 214(7) may produce distinct subchannel components 216(6) and 216(7).

At 208, the process 200 may include bonding subchannel components 216 to form bonded subchannels. The subchannel components 216 are bonded to form bonded component sub-bands 218 or bonded subchannels. The sub-bands are bonded to re-form at 210. The subchannels 212, which are perfectly formed, are passed to the beamformers, at 210. Bent-pipe systems may bypass the reconstruction (bonding) operation and may simply forward the sub-bands. Zero stuffing may be beneficial in the bonding phase where the FFT size is increased and zeros are added to ends of the FFT bins.

FIG. 3 depicts a block diagram of a portion 300 of a receive path configured to provide subchannel bonding in the digital downconverter, in accordance with certain embodiments of the present disclosure. In example embodiments, the numerically controlled oscillator 306 may allow the alignment circuitry 110 to dynamically adjust a frequency offset used to align spectral components of one or more subchannels to a selected raster. As a nonlimiting example, in a satellite receiver experiencing Doppler-induced frequency offset, the numerically controlled oscillator 306 may generate timing signals that cause the alignment circuitry 110 to shift the received spectrum to maintain alignment with an onboard channel raster. Other example embodiments may use different oscillator architectures or may generate different timing signals while still providing timing control to the alignment circuitry as described herein.

In this example, the receive path portion 300 may include the alignment circuitry 110, the fractionally interpolating polyphase analysis bank 112, and one or more fractionally decimating synthesis bonding banks 114.

In this example, the alignment circuitry 110 may include a fractional decimation block 302, which may receive a signal including multiple subchannels from the one or more analog front-end circuits 104. The alignment circuitry 110 may include a fractional decimation block 302, which may resample or encapsulate the spectral components of the subchannels 112 of the received signal. The fractional decimator 302 may support multiple rate changes.

The alignment circuitry 110 may include a multiplier 304 that may include an input coupled to the output of the fractional decimation block 302, a second input coupled to a local oscillator 306 to receive a phase adjustment signal, and an output to provide frequency-adjusted subchannels. In some embodiments, the multiplier 304 may shift spectral components of the decimated signal components. The fractional decimator 302 and the multiplier 304 may be configured to align the subchannels to the raster or at least to encapsulate the spectral components of the incoming signal.

The portion 300 may include the fractionally interpolating polyphase analysis bank 112. The fractionally interpolating polyphase analysis bank 112 may process the signal to oversample the FFT bins to ensure “perfect” reconstruction. In this example, the fractionally interpolating polyphase analysis bank 112 may include an FFT of length 1024, I=5, and D=4, resulting in a slight interpolation.

The portion 300 may include one or more fractionally decimating synthesis bonding banks 114. The fractionally decimating synthesis bonding banks 114 may reconstruct the bonded spectral components in a regenerative system. In this example, the fractionally decimating synthesis bonding banks 114 have a FFT length of 2^{M}, where M is an integer, I=4, and D=5, resulting in a slight decimation. The outputs of the fractionally decimating synthesis bonding banks 114 may be provided to the beamformer network. Each bonding bank may contain signals from one or more different beams (spatial directions) formed in the beamforming network.

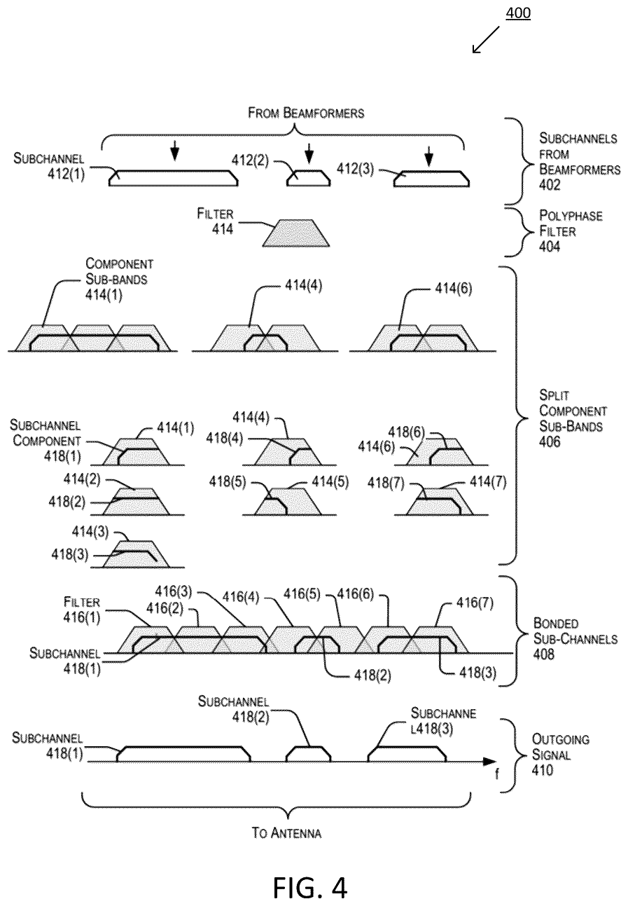

FIG. 4 depicts a diagram of a process 400 of subchannel formation in a digital upconverter according to a desired configuration of beams and bands for a transmit signal, in accordance with certain embodiments of the present disclosure. In this example, the process 400 is performed by circuit components in the transmission path. In example embodiments, the aggregated sub-band components may be combined and bonded by arranging the sub-band components within a desired frequency-domain band plan and summing overlapping spectral components, and a fractionally decimating polyphase synthesis bank 118 may generate an outgoing waveform 410 from the bonded spectral representation. The outgoing waveform 410 may be provided to the alignment circuitry 110 for raster alignment prior to transmission via one or more front-end circuits 104 and one or more antennas 102. As a nonlimiting example, a satellite transmitter may aggregate sub-band components from multiple spot beams that share frequency resources, bond the sub-band components into a composite downlink spectrum, and then align the composite waveform to a transmit raster. Other example embodiments may use different aggregation strategies or bonding arrangements depending on a desired band plan.

At 402, multiple subchannels 412 are passed to the signal processing circuit(s) 106 from the beamformer network 108 where wideband signals were processed with true time delay and narrowband signals were processed with digital phase shifters. Each subchannel 412 may have its own bandwidth and center frequency. Subchannels on different beams (different spatial directions) may overlap in frequency.

At 404, the fractionally interpolating analysis splitting banks 116 may apply a filter 414. The filter 414 may be a Nyquist filter or another filter, depending on the implementation.

At 406, the filters 414 are applied to the subchannels 412 to split the subchannels 412 into subchannel components (sub-bands) 418 forming the encapsulated subchannels 416. The filters 414(1), 414(2), and 414(3) are applied to split the subchannel 412(1) into subchannel components 418(1), 418(2), and 418(3) forming the encapsulated subchannel 416(1). The filters 414(4) and 414(5) are applied to split the subchannel 412(2) into subchannel components 418(4) and 418(5) forming the encapsulated subchannel 416(2). The filters 414(6) and 414(7) are applied to split the subchannel 414(3) into subchannel components 418(6) and 418(7) forming the encapsulated subchannel 416(3).

At 408, the subchannel components (sub-bands) 418 are combined, bonded, and slightly decimated by the fractionally decimating polyphase synthesis bank 116 with filter 416 to form a composite outgoing waveform according to the desired band/beam plan. Bonding comprises arranging subchannel components of a beam to place the encapsulated subchannel at the desired location in the band plan. Combining comprises adding subchannel components from different beams that overlap in frequency. The outgoing waveform or signal 410 may be comprised of the multiple subchannels 412 and may be routed to the one or more antenna(s) 102 (or to the analog front-end circuit(s) 104 for transmission via the antenna(s) 102.

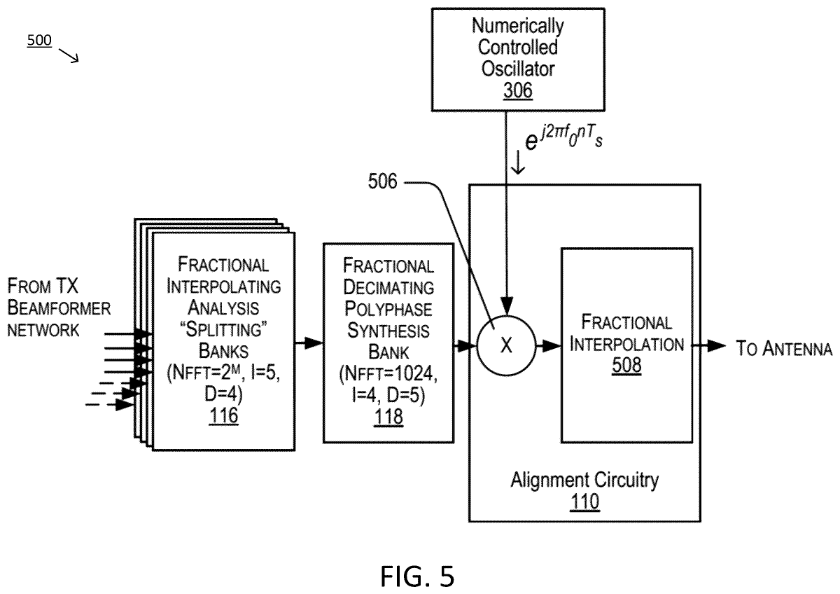

FIG. 5 depicts a block diagram of a portion 500 of a transmit path configured to provide subchannel splitting followed by subchannel bonding in the digital upconverter, in accordance with certain embodiments of the present disclosure. In this example, one or more fractionally interpolating analysis splitting banks 116 may receive subchannels 412 from the beamforming network 108 for transmission via the antenna(s) 102. The fractionally interpolating analysis splitting banks 116 may split subchannels 412 into oversampled sub-band spectral components in a regenerative system. Bent-pipe systems may bypass this functionality. In particular, the bent-pipe systems may bypass the reconstruction (bonding) operation 208 and may simply forward the sub-bands. Zero stuffing may be beneficial in the bonding phase where the FFT size is increased and zeros are added to ends of the FFT bins.

The portion 500 may include the fractionally decimating polyphase synthesis bank 118, which may receive the sub-band spectral components from the fractionally interpolating analysis splitting banks 116 and may combine, bond, and slightly decimate the sub-bands to form an outgoing waveform, which may be provided to alignment circuitry 110. Combining refers to adding those sub-band spectral components of different beams (spatial directions) generated by the splitting banks 116 that overlap in frequency.

The alignment circuitry 110 may be configured to frequency-shift the spectral components of the waveform to realign the outgoing waveform to a selected raster or at least to encapsulate the spectral components of the outgoing signal. The alignment circuitry 110 may include a multiplier 506 that may include an input coupled to the output of the fractionally decimating polyphase synthesis bank 118, a second input coupled to the local oscillator 306 to receive a phase adjustment signal, and an output coupled to an input of a fractional interpolation block 508. The fractional interpolation block 508 may be configured to selectively resample the spectral components to assist in realigning the outgoing waveform to the selected raster and perform rate-matching with the RF front-end circuit(s) 104. The fractional interpolation block 508 may be configured to support multiple rate changes. The fractional interpolation block 508 may provide the adjusted outgoing waveform to the RF front-end circuit(s) 104 for transmission via the antenna(s) 102.

In an example, using a digital signal processor (DSP) clock and the local oscillator (LO) 306, the incoming/outgoing signal may be mapped to a selected raster. In some embodiments, the subchannels of the incoming/outgoing signals can be aligned to the selected raster by adjusting the sample rate, adjusting the LO 306, and adjusting spectral components of the signal. In an example, by adjusting the DSP clock, the sample rate and hence the raster is adjusted. The frequency separation on the raster may be determined by the length of the Fast Fourier Transform (FFT) and the sample rate may be determined according to equation 1, which is repeated here:

$${f}_{Δ} = \frac{{f}_{s}}{{N}_{fft}} \qquad ( 20 )$$

where f_{Δ} represents the frequency adjustment, fₛ represents the sample frequency, and N_{fft} represents the length of the FFT. In some embodiments, the raster offset may be adjusted by the LO 306.

The alignment circuitry 110 may be configured to align to a raster by resampling and shifting the spectral components of the signal. The alignment circuitry 110 may use fractional decimation block 302 to create the selected grid spacing and a frequency shift can align the grid. A fractional re-sampler may cost up to 32×2 real multiply operations per sample and a frequency shift may cost an additional complex multiply operation, which may be very expensive computationally.

In other embodiments, the alignment circuitry 110 may be configured to encapsulate the received signal in the framework of an existing raster grid, which is not aligned to the signal raster. The encapsulated signal may be processed without the added multiply operations performed by the re-sampler in the example described above. Increasing the resolution of an FFT may cost one-half of a complex multiply operation per sample, which is computationally cheap when compared to a fractional re-sampler. In some embodiments, a baseband signal can be resampled with even a difficult rate change. A deterministic frequency shift may be applied in the baseband processing, shifting the burden of the raster alignment to baseband processing.

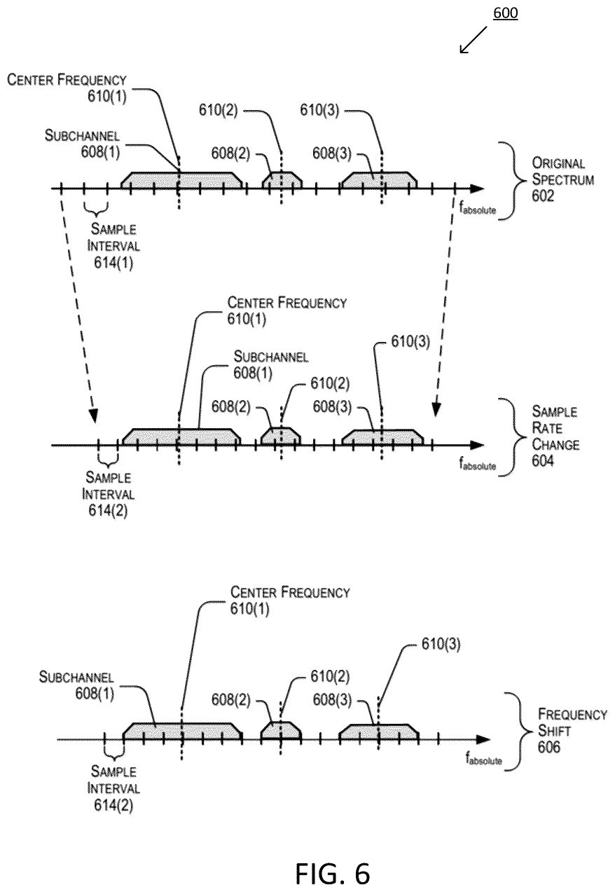

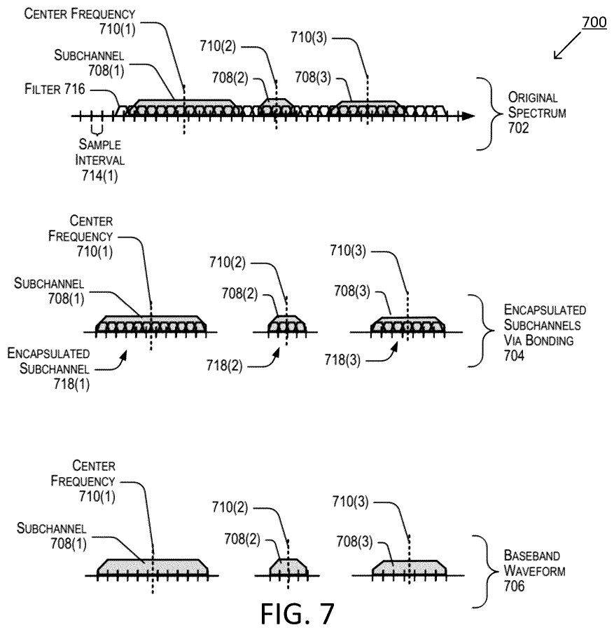

In FIGS. 6 and 7, the alignment and encapsulation solutions are depicted and described. In FIG. 6, the clock rate may be adjusted to adjust the raster and the local oscillator 306 may be adjusted to adjust the signal to the selected raster.

FIG. 6 depicts a diagram of a process 600 of subchannel alignment through resampling or clock-rate adjustment and digital frequency shift or local oscillator shift, in accordance with certain embodiments of the present disclosure. At 602, the incoming signal with its original subchannel spectrum is received and shown relative to the raster defined by one or more of the DSP clock or the local oscillator 306. The signal includes subchannels 608, each of which has its own center frequency 610. The raster has a sample interval 614(1).

At 604, the sample rate or raster frequency is changed, producing a raster having a second sample interval 614(2). The subchannels 608 and their respective center frequencies 610 are shown relative to (but not aligned to) the adjusted raster.

At 606, a frequency shift is applied to the subchannels 608, aligning the edges of the subchannels 608 to the raster. In this example, the subchannels 608 are shifted toward the left in the drawing, aligning the subchannels 608 and their respective center frequencies 610 to the raster. In this example, the offset of the subchannels 608 may be provided by adjusting the local oscillator 306. The alignment circuitry 110 may be configured to align to a raster by resampling and shifting the spectral components of the signal. The alignment circuitry 110 may use fractional decimation block 302 to create the selected grid spacing and a frequency shift can align the grid.

A second approach may be used to align the subchannels to the raster in which the incoming signal is encapsulated and the encapsulated signal may be processed, for example, at baseband. An example is described below with respect to FIG. 7.

FIG. 7 depicts a diagram of a process 700 of encapsulation through oversampling in the frequency domain and alignment at baseband through one or more of digital frequency shift or rate change, in accordance with certain embodiments of the present disclosure.

In some example embodiments, FIG. 7 illustrates a process 700 for encapsulating spectral components of one or more subchannels and aligning the encapsulated spectral components to a selected raster that may be performed by the alignment circuitry 110 in example embodiments. In example embodiments, the alignment circuitry 110 may apply a filter 716 to an incoming signal to oversample the incoming signal in the frequency domain, thereby encapsulating spectral components of a plurality of subchannels 708 within an existing raster that is not initially aligned to the subchannels. The alignment circuitry 110 may adjust a resolution of a Fast Fourier Transform operation, such as by increasing an FFT length or an effective oversampling factor, so that FFT bin spacing more finely partitions the spectrum and allows the encapsulated spectral components to be represented by groups of adjacent FFT bins corresponding to raster intervals.

In example embodiments, after encapsulation, the alignment circuitry 110 may align the encapsulated spectral components to the selected raster using baseband processing operations. As a nonlimiting example, the alignment circuitry 110 may apply a deterministic digital frequency shift to one encapsulated subchannel and may apply a combination of a baseband sample-rate change and a frequency shift to another encapsulated subchannel, depending on a relative offset between each subchannel and the selected raster. In a real-world satellite payload example, a received uplink signal that occupies a frequency region misaligned with an onboard channel raster may be encapsulated using FFT oversampling, and the encapsulated subchannels may then be aligned at baseband without requiring a wideband fractional resampler. Other example embodiments may use different FFT sizes, different oversampling ratios, or different baseband alignment techniques while still encapsulating and aligning spectral components as described herein.

At 702, the original spectrum of the incoming signal is received. The original signal may include a plurality of subchannels 708, each of which may have its own center frequency 710. A filter 716 may be applied to the incoming signal to oversample the subchannels 708. There is a sample interval 714(1) in this example as well.

At 704, the subchannels 708 may be encapsulated by bonding, producing encapsulated subchannels 718. At 706, the subchannels are extracted to produce baseband waveforms. In this example, the subchannels 708(1) and 708(2) may be aligned at baseband using a frequency shift. The subchannel 708(3) may be aligned at baseband using a sample rate change and a frequency shift.

The alignment circuitry 110 may be configured to encapsulate the received signal in the framework of an existing raster grid, which is not aligned to the signal raster. The encapsulated signal may be processed without the added multiply operations that may need to be performed by a re-sampler in the raster adjustment example above. Increasing the resolution of an FFT may cost one-half of a complex multiply operation per sample, which is computationally cheap when compared to a fractional re-sampler. In some embodiments, a baseband signal can be resampled with even a difficult rate change. A deterministic frequency shift may be applied in the baseband processing, shifting the burden of the raster alignment to baseband processing.

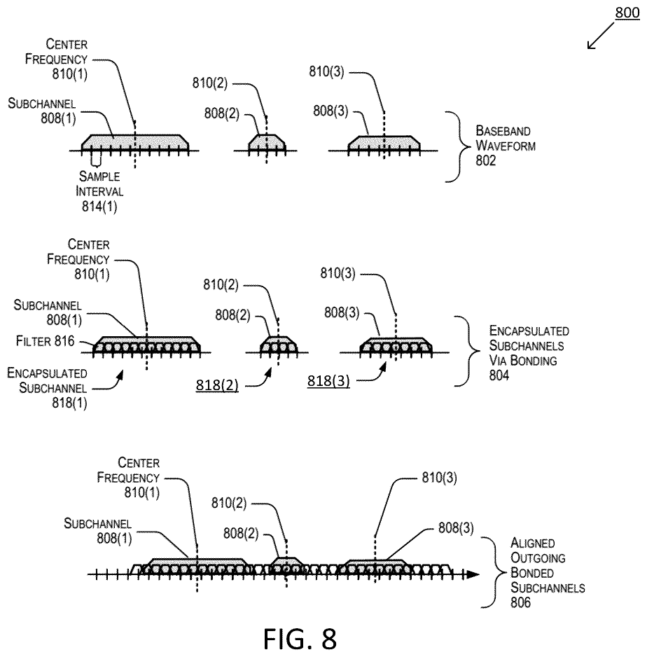

In some embodiments, it may be desirable to align the outgoing waveform to the raster. The transmission path may benefit from frequency shifts and almost certainly sample rate changes at baseband to align the outgoing subchannels to the raster. An example is described below with respect to FIG. 8.

FIG. 8 depicts a diagram of a process 800 of aligning subchannels to raster intervals in the digital upconverter, in accordance with certain embodiments of the present disclosure. At 802, the transmission path may receive the baseband waveform, which may include multiple subchannels 808. Each subchannel 808 may have its own center frequency 810. There is a sample interval 814(1) in this example as well.

Filters 816 may be applied to the subchannels 808 to form encapsulated subchannels 818. At 804, the encapsulated subchannels 818 are formed via bonding. The sub-bands of the subchannels 808 may be formed and then bonded together.

At 806, the bonded subchannels 818 are aligned to form the outgoing signal. As previously discussed, the alignment circuitry 110 may be configured to encapsulate the received signal in the framework of an existing raster grid, which is not aligned to the signal raster. The encapsulated signal may be processed without the added multiply operations performed by the re-sampler in the example described above. Increasing the resolution of an FFT may cost one-half of a complex multiply operation per sample, which is computationally cheap when compared to a fractional re-sampler. In some embodiments, a baseband signal can be resampled with even a difficult rate change. A deterministic frequency shift may be applied in the baseband processing, shifting the burden of the raster alignment to baseband processing.

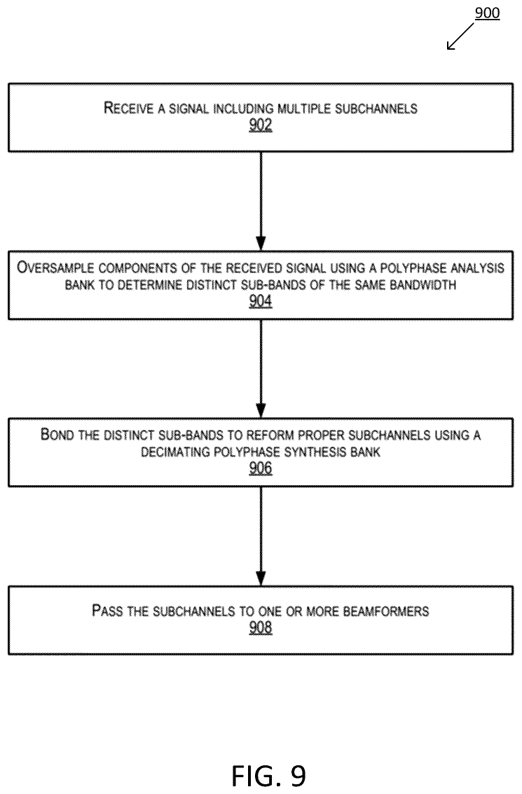

FIG. 9 depicts a flow diagram of a method 900 of subchannel formation in a digital downconverter for a received signal, in accordance with certain embodiments of the present disclosure. At 902, the method 900 may include receiving a signal including multiple subchannels. Subchannels may be associated with different beams (spatial directions) and hence overlap in frequency. The signal may be received from the one or more antenna(s) 102 via the analog front-end circuit(s) 104.

At 904, the method 900 may include oversampling components of the received signal using a polyphase analysis bank 112 to determine distinct sub-bands of the same bandwidth. The subchannels of the received signal may be oversampled to define the distinct sub-band components.

At 906, the method 900 may include bonding the distinct sub-bands to reform “proper” or “perfect” subchannels using a decimating polyphase synthesis bank 114. The sub-bands may be bonded together to reform the subchannels.

At 908, the method 900 may include passing or routing the subchannels to one or more beamformers. The signal processing circuit(s) 106 may pass or route the subchannels to the beamformer network 108.

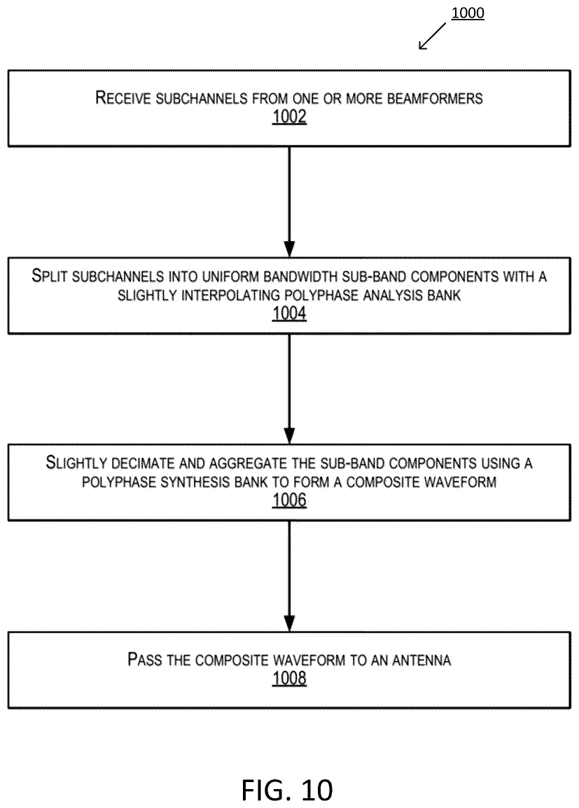

FIG. 10 depicts a flow diagram of a method 1000 of subchannel formation in a digital upconverter for a signal to be transmitted, in accordance with certain embodiments of the present disclosure. At 1002, the method 1000 may include receiving subchannels from one or more beamformers. The signal processing circuit(s) 106 may receive subchannels from the beamformer network 108.

At 1004, the method 1000 may include splitting the subchannels into uniform-bandwidth sub-band components using a slightly interpolating polyphase analysis bank 116. The subchannels may be oversampled to split the subchannels into the sub-band components.

At 1006, the method 1000 may include slightly decimating and aggregating the sub-band components using a polyphase synthesis bank 118 to form a composite waveform. The polyphase synthesis bank 118 may be configured to bond the sub-band components to form the outgoing waveform.

At 1008, the method 1000 may include passing or routing the composite (outgoing) waveform to an antenna(s) 102. In an example, the signal processing circuit(s) 106 may route the outgoing waveform to the front-end circuit(s) 104, which may drive the one or more antenna(s) 102 to transmit the signal.

In conjunction with the systems and methods described above with respect to FIGS. 1-10, a system may include signal processing circuit(s) 106 configured to use a filter to split subchannels of a signal (received signal or signal for transmission) into a plurality of distinct sub-bands. The signal processing circuit(s) 106 may be configured to assemble and bond the distinct sub-bands to reform the subchannel, which may be provided to a beamforming network 108 or which may be combined into a composite outgoing waveform that may be provided to a front-end circuit(s) 104 for transmission via the antenna(s) 102. In some embodiments, subchannels may be aligned to a selected raster at the baseband. Other embodiments are also possible.

Various embodiments may be described in the following clauses:

1. A system, comprising:
a plurality of front-end circuits coupled to a plurality of antennas to send and receive signals;
a beamforming network configured to communicate one or more beams to other circuitry; and
a plurality of signal processing circuits coupled between the front-end circuits and the beamforming network, wherein individuals ones of the plurality of signal processing circuits comprise:
alignment circuitry coupled to the plurality of front-end circuits and configured to selectively align signal components to a selected raster;
a receive path configured to fractionally interpolate an incoming signal from the alignment circuitry to determine one or more sub-bands from each of a plurality of subchannels within the incoming signal and to fractionally decimate and bond the one or more sub-bands to reconstruct the plurality of subchannels and provide the plurality of subchannels to the beamforming network; and
a transmit path configured to fractionally interpolate a plurality of subchannels from the beamforming network to determine one or more sub-bands from each of a plurality of subchannels and to combine, bond, and fractionally decimate the one or more sub-bands to reconstruct the plurality of subchannels and provide the plurality of subchannels to the alignment circuitry for transmission via the plurality of antennas.
   2. The system of clause 1, wherein the alignment circuitry is configured to re-sample and shift spectral components of the plurality of subchannels to a selected raster.
   3. The system of clause 1, wherein the alignment circuitry is configured to encapsulate spectral components of the plurality of subchannels and to align the encapsulated spectral components to a selected raster.
   4. The system of clause 1, wherein the receive path comprises:
a fractionally interpolating polyphase analysis bank configured to oversample the incoming signal using a filter to determine one or more sub-bands from each of the plurality of subchannels; and
one or more fractionally decimating synthesis bonding banks configured to bond the one or more sub-bands to reconstruct the subchannels and provide the subchannels to the beamforming network.
   5. The system of clause 4, wherein the fractionally interpolating polyphase analysis bank and the one or more fractionally decimating synthesis bonding banks are part of a digital downconverter.
   6. The system of clause 1, wherein the transmit path comprises:
one or more fractionally interpolating analysis splitting banks configured to oversample the plurality of subchannels from the beamforming network to determine one or more sub-bands from each of the plurality of subchannels; and
fractionally decimating polyphase synthesis banks configured to combine and bond the one or more sub-bands to construct an outgoing waveform including the plurality of subchannels and provide the outgoing waveform to the alignment circuitry.
   7. The system of clause 6, wherein the fractionally interpolating analysis splitting bank and the one or more fractionally decimating polyphase synthesis banks are part of a digital upconverter.
   8. The system of clause 1, wherein, in a bent-pipe communication path, the plurality of signal processing circuits are configured to:
avoid bonding the one or more sub-bands; and
forward the one or more sub-bands to a destination device.
   9. A method comprising:
in a receive path:
selectively aligning signal components of an incoming signal to a selected raster;
fractionally interpolating the incoming signal from alignment circuitry to determine one or more sub-bands from each of a plurality of subchannels within the incoming signal;
fractionally decimating and bonding the one or more sub-bands to reconstruct the plurality of subchannels; and
   providing the plurality of subchannels to a beamforming network; and
in a transmit path:
fractionally interpolating a plurality of subchannels from the beamforming network to determine one or more sub-bands from each of a plurality of subchannels;
fractionally decimating, aggregating, and bonding the one or more sub-bands to reconstruct the plurality of subchannels; and
selectively aligning the plurality of subchannels to the selected raster for transmission via an antenna.
   10. The method of clause 9, wherein selectively aligning comprises
resampling spectral components of each of the plurality of subchannels; and
selectively shifting the spectral components of the plurality of subchannels; and
wherein resampling and selectively shifting are controlled to align the plurality of subchannels to the selected raster.
   11. The method of clause 9, wherein selectively aligning comprises:
applying a filter to the plurality of subchannels to form an encapsulated signal; and
adjusting a resolution of a Fast Fourier Transform operation to align encapsulated spectral components of the plurality of subchannels to the selected raster.
   12. The method of clause 9, wherein fractionally interpolating comprises applying a filter to oversample the incoming signal to determine the one or more sub-bands from each of the plurality of subchannels.
   13. The method of clause 9, wherein fractionally decimating comprises:
assembling the one or more sub-bands;
reconstructing the plurality of subchannels by bonding the sub-bands; and
providing the reconstructed plurality of subchannels to the beamforming network.
   14. The method of clause 9, wherein the fractionally interpolating of the plurality of subchannels comprises:
oversampling the plurality of subchannels from the beamforming network to determine one or more sub-bands from each of the plurality of subchannels;
aggregating the one or more sub-bands;
constructing an outgoing waveform by bonding the one or more sub-bands; and
providing the outgoing waveform to the alignment circuitry.
   15. The method of clause 9, wherein, in a bent-pipe communication path, the method further comprises:
avoiding bonding the one or more sub-bands; and
forwarding the sub-bands to a destination device.
   16. A system comprises:
a front-end circuit coupled to a single antenna to send and receive signals; and
   a signal processing circuit coupled to the front-end circuit, the signal processing circuit comprising:
alignment circuitry coupled to the front-end circuit and configured to encapsulate spectral components of a plurality of subchannels and to align the encapsulated spectral components to a selected raster;
a receive path configured to fractionally interpolate an incoming signal from the alignment circuitry to determine one or more sub-bands from each of the plurality of subchannels within the incoming signal and to fractionally decimate and bond the one or more sub-bands to reconstruct the plurality of subchannels; and
a transmit path configured to fractionally interpolate the plurality of subchannels from the receive path to determine one or more sub-bands from each of a plurality of subchannels and to combine, bond, and fractionally decimate the one or more sub-bands to reconstruct the plurality of subchannels and provide the plurality of subchannels to the alignment circuitry for transmission via the single antenna.
   17. The system of clause 16, further comprising a numerically controlled oscillator to provide one or more timing signals to the alignment circuitry.
   18. The system of clause 16, wherein the receive path comprises:
a fractionally interpolating polyphase analysis bank configured to oversample the incoming signal using a filter to determine one or more sub-bands; and
one or more fractionally decimating synthesis bonding banks configured to bond the one or more sub-bands to reconstruct the plurality of subchannels; and
wherein the fractionally interpolating polyphase analysis bank and the one or more fractionally decimating synthesis bonding banks are part of a digital downconverter.
   19. The system of clause 16, wherein the transmit path comprises:
one or more fractionally interpolating analysis splitting banks configured to oversample the plurality of subchannels to determine one or more sub-bands from each of the plurality of subchannels; and
a fractionally decimating polyphase synthesis bank configured to combine and bond the one or more sub-bands to construct an outgoing waveform including the plurality of subchannels and provide the outgoing waveform to the alignment circuitry; and
wherein the one or more fractionally interpolating analysis splitting banks and the fractionally decimating polyphase synthesis banks are part of a digital upconverter.
   20. The system of clause 16, wherein, in a bent-pipe communication path, the signal processing circuit is configured to:
avoid bonding the one or more sub-bands; and
forward the sub-bands to a destination device.
   21. A method for operating a portable communications device of any of clauses 1-20.
   22. A non-transitory computer-readable storage medium including instructions that, when executed by at least one processor, cause the at least one processor to perform communications using the portable communications device of any of clauses 1-20.
   23. A satellite-based communication system including at least one portable communications device of any of clauses 1-20.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit disclosure to a specific form or forms disclosed, but on the contrary, the intention is to cover all modifications, alternative constructions, and equivalents falling within the spirit and scope of disclosure, as defined in the appended claims.

Use of terms “a” and “an” and “the” and similar referents in the context of describing disclosed embodiments (especially in the context of the following claims) is to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein is merely intended to serve as a shorthand method of referring individually to each separate value falling within range, unless otherwise indicated herein, and each separate value is incorporated into the specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, a set of non-transitory computer-readable storage media comprises multiple non-transitory computer-readable storage media, and one or more of the individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium stores instructions and a main central processing unit (“CPU”) executes some of the instructions while a graphics processing unit (“GPU”) executes other instructions. In at least one embodiment, different components of a computer system have separate processors, and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operations such as addition, subtraction, or multiplication. In at least one embodiment, an arithmetic logic unit is used to implement logical operations such as logical AND/OR or XOR. In at least one embodiment, an arithmetic logic unit is stateless and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to the inputs of the arithmetic logic unit. In at least one embodiment, the instruction codes provided by the processor to the ALU are based at least in part on the instruction executed by the processor. In at least one embodiment, combinational logic in the ALU processes the inputs and produces an output that is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein, and such computer systems are configured with applicable hardware and/or software that enable performance of operations. Further, a computer system that implements at least one embodiment of the present disclosure is a single device and, in another embodiment, is a distributed computer system comprising multiple devices that operate differently, such that the distributed computer system performs operations described herein and such that a single device does not perform all operations.

Use of any and all examples, or exemplary language (e.g., “such as”) provided herein, is intended merely to better illuminate embodiments of disclosure and does not pose a limitation on the scope of disclosure unless otherwise claimed. No language in the specification should be construed as indicating any non-claimed element as essential to the practice of disclosure.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but still cooperate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from a providing entity to an acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an interprocess communication mechanism.

Although descriptions herein set forth example implementations of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
a plurality of front-end circuits coupled to a plurality of antennas to send and receive signals;
a beamforming network configured to communicate one or more beams to other circuitry; and
a plurality of signal processing circuits coupled between the front-end circuits and the beamforming network, wherein individuals ones of the plurality of signal processing circuits comprise:
alignment circuitry coupled to the plurality of front-end circuits and configured to selectively align signal components to a selected raster;
a receive path configured to fractionally interpolate an incoming signal from the alignment circuitry to determine one or more sub-bands from each of a plurality of subchannels within the incoming signal and to fractionally decimate and bond the one or more sub-bands to reconstruct the plurality of subchannels and provide the plurality of subchannels to the beamforming network; and
a transmit path configured to fractionally interpolate a plurality of subchannels from the beamforming network to determine one or more sub-bands from each of a plurality of subchannels and to combine, bond, and fractionally decimate the one or more sub-bands to reconstruct the plurality of subchannels and provide the plurality of subchannels to the alignment circuitry for transmission via the plurality of antennas.

2. The system of claim 1, wherein the alignment circuitry is configured to re-sample and shift spectral components of the plurality of subchannels to a selected raster.

3. The system of claim 1, wherein the alignment circuitry is configured to encapsulate spectral components of the plurality of subchannels and to align the encapsulated spectral components to a selected raster.

4. The system of claim 1, wherein the receive path comprises:
a fractionally interpolating polyphase analysis bank configured to oversample the incoming signal using a filter to determine one or more sub-bands from each of the plurality of subchannels; and
one or more fractionally decimating synthesis bonding banks configured to bond the one or more sub-bands to reconstruct the subchannels and provide the subchannels to the beamforming network.

5. The system of claim 4, wherein the fractionally interpolating polyphase analysis bank and the one or more fractionally decimating synthesis bonding banks are part of a digital downconverter.

6. The system of claim 1, wherein the transmit path comprises:
one or more fractionally interpolating analysis splitting banks configured to oversample the plurality of subchannels from the beamforming network to determine one or more sub-bands from each of the plurality of subchannels; and
fractionally decimating polyphase synthesis banks configured to combine and bond the one or more sub-bands to construct an outgoing waveform including the plurality of subchannels and provide the outgoing waveform to the alignment circuitry.

7. The system of claim 6, wherein the fractionally interpolating analysis splitting bank and the one or more fractionally decimating polyphase synthesis banks are part of a digital upconverter.

8. The system of claim 1, wherein, in a bent-pipe communication path, the plurality of signal processing circuits are configured to:
avoid bonding the one or more sub-bands; and
forward the one or more sub-bands to a destination device.

9. A method comprising:
in a receive path:
selectively aligning signal components of an incoming signal to a selected raster;
fractionally interpolating the incoming signal from alignment circuitry to determine one or more sub-bands from each of a plurality of subchannels within the incoming signal;
fractionally decimating and bonding the one or more sub-bands to reconstruct the plurality of subchannels; and
providing the plurality of subchannels to a beamforming network; and
in a transmit path:
fractionally interpolating a plurality of subchannels from the beamforming network to determine one or more sub-bands from each of a plurality of subchannels;
fractionally decimating, aggregating, and bonding the one or more sub-bands to reconstruct the plurality of subchannels; and
selectively aligning the plurality of subchannels to the selected raster for transmission via an antenna.

10. The method of claim 9, wherein selectively aligning comprises
resampling spectral components of each of the plurality of subchannels; and
selectively shifting the spectral components of the plurality of subchannels; and
wherein resampling and selectively shifting are controlled to align the plurality of subchannels to the selected raster.

11. The method of claim 9, wherein selectively aligning comprises:
applying a filter to the plurality of subchannels to form an encapsulated signal; and
adjusting a resolution of a Fast Fourier Transform operation to align encapsulated spectral components of the plurality of subchannels to the selected raster.

12. The method of claim 9, wherein fractionally interpolating comprises applying a filter to oversample the incoming signal to determine the one or more sub-bands from each of the plurality of subchannels.

13. The method of claim 9, wherein fractionally decimating comprises:
assembling the one or more sub-bands;
reconstructing the plurality of subchannels by bonding the sub-bands; and
providing the reconstructed plurality of subchannels to the beamforming network.

14. The method of claim 9, wherein the fractionally interpolating of the plurality of subchannels comprises:
oversampling the plurality of subchannels from the beamforming network to determine one or more sub-bands from each of the plurality of subchannels;
aggregating the one or more sub-bands;
constructing an outgoing waveform by bonding the one or more sub-bands; and
providing the outgoing waveform to the alignment circuitry.

15. The method of claim 9, wherein, in a bent-pipe communication path, the method further comprises:
avoiding bonding the one or more sub-bands; and
forwarding the sub-bands to a destination device.

16. A system comprises:
a front-end circuit coupled to a single antenna to send and receive signals; and
a signal processing circuit coupled to the front-end circuit, the signal processing circuit comprising:
alignment circuitry coupled to the front-end circuit and configured to encapsulate spectral components of a plurality of subchannels and to align the encapsulated spectral components to a selected raster;
a receive path configured to fractionally interpolate an incoming signal from the alignment circuitry to determine one or more sub-bands from each of the plurality of subchannels within the incoming signal and to fractionally decimate and bond the one or more sub-bands to reconstruct the plurality of subchannels; and
a transmit path configured to fractionally interpolate the plurality of subchannels from the receive path to determine one or more sub-bands from each of a plurality of subchannels and to combine, bond, and fractionally decimate the one or more sub-bands to reconstruct the plurality of subchannels and provide the plurality of subchannels to the alignment circuitry for transmission via the single antenna.

17. The system of claim 16, further comprising a numerically controlled oscillator to provide one or more timing signals to the alignment circuitry.

18. The system of claim 16, wherein the receive path comprises:
a fractionally interpolating polyphase analysis bank configured to oversample the incoming signal using a filter to determine one or more sub-bands; and
one or more fractionally decimating synthesis bonding banks configured to bond the one or more sub-bands to reconstruct the plurality of subchannels; and
wherein the fractionally interpolating polyphase analysis bank and the one or more fractionally decimating synthesis bonding banks are part of a digital downconverter.

19. The system of claim 16, wherein the transmit path comprises:
one or more fractionally interpolating analysis splitting banks configured to oversample the plurality of subchannels to determine one or more sub-bands from each of the plurality of subchannels; and
a fractionally decimating polyphase synthesis bank configured to combine and bond the one or more sub-bands to construct an outgoing waveform including the plurality of subchannels and provide the outgoing waveform to the alignment circuitry; and
wherein the one or more fractionally interpolating analysis splitting banks and the fractionally decimating polyphase synthesis banks are part of a digital upconverter.

20. The system of claim 16, wherein, in a bent-pipe communication path, the signal processing circuit is configured to:
avoid bonding the one or more sub-bands; and
forward the sub-bands to a destination device.
